(19) United States
(12) Patent Application Publication
(10) Pub. No.: US 2002/0121427 A1
(43) Pub. Date: Sep. 5, 2002

(54) Belt conveyor for feeding sheets of glass on a grinding machine, and grinding machine comprising such a conveyor

(76) Inventor: Pierfranco Margaria, Valgioie (IT)

Correspondence Address: SHERIDAN ROSS PC, 1560 BROADWAY, SUITE 1200, DENVER, CO, 80202

(21) Appl. No.: 10/027,260

(22) Filed: Dec. 19, 2001

(30) Foreign Application Priority Data
Dec. 19, 2000 (IT) TO2000A001180

(51) Int. Cl. B65G 13/02

(52) U.S. Cl. 198/689.1

(57) ABSTRACT

On a machine for grinding sheets of glass, a sheet of glass for grinding is fed along a grinding path by a belt conveyor having a supporting structure, and a single powered toothed belt defined by a continuous supporting surface for supporting the sheet of glass; the belt having a retaining device which acts on the surface of the sheet of glass facing the supporting surface to keep the sheet of glass in contact with the supporting surface.

The present invention relates to a belt conveyor for feeding a sheet of glass on a grinding machine.

The present invention may be used to advantage particularly, though not exclusively, on two-sided machines, to which the following description refers purely by way of example.

### BACKGROUND OF THE INVENTION

As is known, a two-sided machine comprises one or more grinding heads; and a feed unit for retaining the work sheet in a reference position and feeding the sheet between the grinding heads.

Known feed units normally comprise one or more pairs of facing belt conveyors; and the conveyors in each pair comprise respective endless belts, normally toothed and made of elastomeric material and having respective facing feed branches which are forced, in use, against each other to grip the sheet to be retained and fed forward.

Though widely used, known feed units of the type described above are unsatisfactory, mainly on account of the fact that they cannot be used for all types of sheets, and in particular for coated sheets of glass, i.e. sheets having an extensive surface coated with a layer of coating material. As is known, in most cases, the coating is extremely fragile, so that any contact with it when handling or machining the sheet must be avoided at all costs, which is impossible on known machines of the type described, on which the coating would be damaged by inevitable contact with one of the feed belts.

### SUMMARY OF THE INVENTION

It is an object of the present invention to provide a sheet-feed belt conveyor designed to provide a straightforward, low-cost solution to the above problem.

According to the present invention, there is provided a belt conveyor for feeding a sheet of glass on a machine for grinding sheets of glass, the conveyor comprising a supporting structure; and a powered toothed belt having a supporting surface for supporting the sheet of glass; characterized in that said toothed belt comprises retaining means which act on the surface of the sheet of glass facing said supporting surface to keep the sheet of glass in contact with said supporting surface.

### BRIEF DESCRIPTION OF THE DRAWINGS

A non-limiting embodiment of the invention will be described by way of example with reference to the accompanying drawings, in which:

FIG. 1 shows, schematically and substantially in block form, a machine for grinding sheets of glass and featuring a belt conveyor in accordance with the teachings of the present invention;

FIGS. 2 and 3 show larger-scale sections, with parts removed for clarity, of a detail of FIG. 1 in two different operating positions;

FIG. 4 shows a much larger-scale section of a variation of a detail in FIGS. 2 and 3;

FIG. 5 shows a partial view in the direction of arrow A in FIG. 3;

FIGS. 6 and 7 are similar to, and show a variation of a detail in, FIGS. 2 and 3 respectively;

FIG. 8 shows a further variation of a detail in FIGS. 6 and 7.

### DETAILED DESCRIPTION OF THE INVENTION

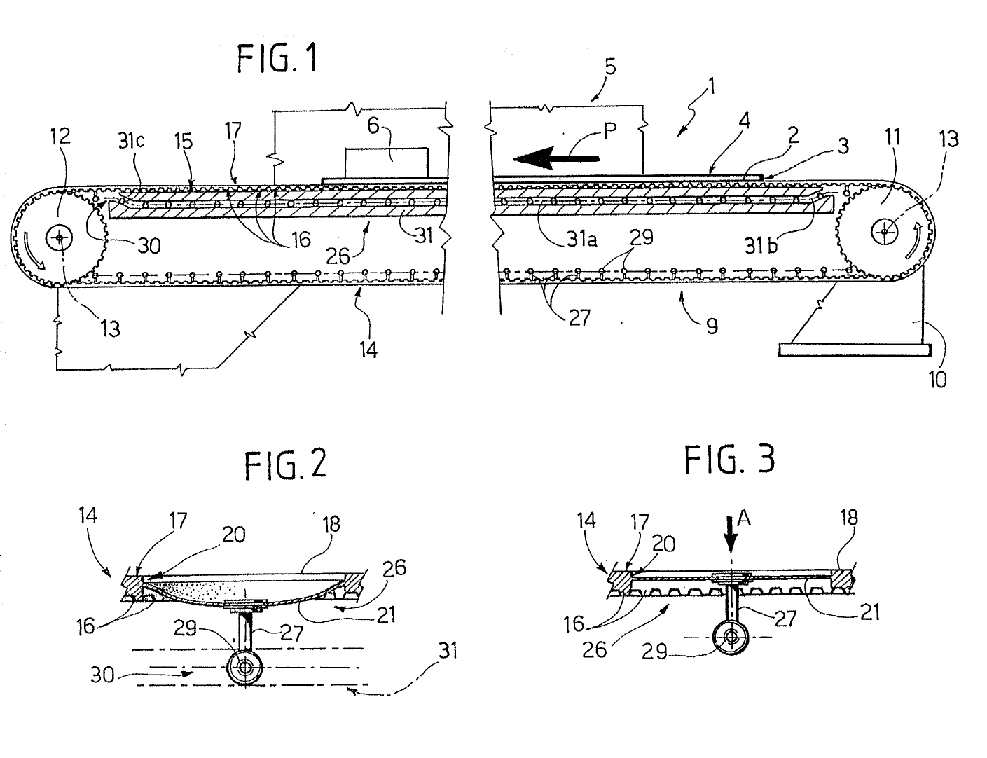

Number 1 in FIG. 1 indicates as a whole a grinding machine, which may be used for grinding both ordinary sheets of glass and coated sheets of glass 2, wherein the extensive surface of an ordinary sheet 3 of glass is coated with a layer 4 of coating material selectable from a number of coating materials.

Machine 1 comprises two lateral shoulders 5, only one of which is shown partly in FIG. 1; and, for each shoulder 5, a respective known grinding unit 6 for grinding a peripheral portion of coated sheet of glass 2, and a respective belt conveyor 9 for feeding sheet 2 along a grinding path P extending through units 6. Each conveyor 9 is adjacent to respective shoulder 5, and comprises a supporting structure 10, and two toothed wheels 11 and 12—one of which is powered—rotating about respective axes 13, and about which is looped a toothed belt 14 for supporting, retaining and advancing coated sheet 2, and which runs in contact with a guide track 15 formed on structure 10, between wheels 11 and 12, and perpendicular to axes 13.

Belt 14 comprises a number of teeth 16, and is defined, on the opposite side to teeth 16, by a continuous elongated supporting surface 17 for supporting sheet 2. As shown, particularly in FIG. 5, belt 14 comprises a supporting portion 18 defined by supporting surface 17 and itself defining a number of outwardly open cavities or seats 20 equally spaced along belt 14.

As shown in FIGS. 2, 3, 6 and 7, each seat 20 is defined by a bottom wall in turn defined, in the example shown, by an elastically deformable membrane 21, a peripheral edge of which is integral with supporting portion 18, so that supporting portion 18 and the membranes form part of a single annular body.

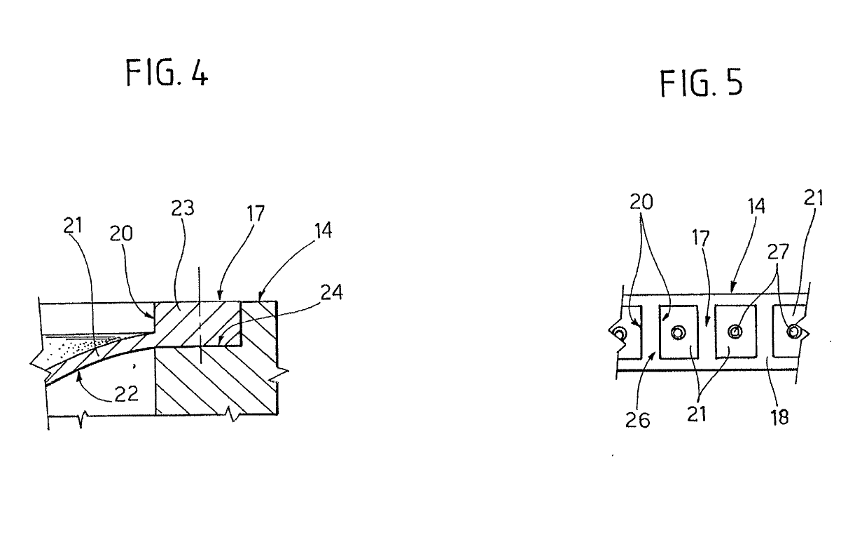

Alternatively, as shown in FIG. 4, each membrane 21 defines the intermediate portion of an independent body 22, which is separate from supporting portion 18 and comprises a peripheral annular connecting portion 23 for connection to supporting portion 18. In the example shown, annular portion 23 rests on an annular shoulder 24, and is either glued or connected releasably to supporting portion 18, e.g. by means of screws, rivets or similar devices.

Membrane 21, annular connecting portion 23 (if any), and supporting surface 17 form part of a vacuum retaining device 26 for retaining sheet 2 on belt 14. In the example shown in FIGS. 1-3 and 5, device 26 also comprises, for each membrane 21, a respective control member 27 for controlling membrane 21 and which is connected integrally to membrane 21, extends outwards of belt 14, on the opposite side to supporting surface 17 and perpendicularly to axes 13, and terminates with a tappet member defined, in the example shown, by two wheels 29 rotating about a common axis parallel to axes 13. Wheels 29 and relative control member 27 form part of a mechanical device 30 for flexing relative membrane 21, and which also comprises a guide or cam 31 fitted integrally to structure 10, between wheels 11 and 12 and along guide track 15, and defining a rolling track for wheels 29. More specifically, guide 31 comprises a straight, intermediate portion 31 a parallel to and spaced transversely apart from track 15; a contoured input portion 31b; and a contoured output portion 31c.

In actual use, and with reference to one seat 20 for the sake of simplicity, coated sheet 2 is fed to conveyor 9 with layer 4 of coating material facing upwards (FIG. 1), and an end portion of sheet 2 is rested on belt 14 adjacent to wheel 11. At this point, conveyor 9 is activated, and seat 20 is fed along path P. That is, seat 20 first travels along an initial portion of path P in which relative membrane 21 is maintained in a rest condition, as shown in FIG. 3, seeing as guide 31 is not yet engaged by wheels 29, so that sheet 2 as yet simply rests on belt 14. As soon as wheels 29 start to run along portion 31b, membrane 21 is gradually flexed downwards (FIGS. 2 and 4) to attract the portion of sheet 2 facing seat 20 by forming a vacuum inside seat 20, which forces sheet 2 against supporting surface 17 to secure sheet 2 in a fixed position with respect to belt 14. This action, which reaches its maximum force by the time wheels 29 run along the end of portion 31b, remains more or less constant throughout the travel of wheels 29 along portion 31a, i.e. throughout the time the edges of sheet 2 are being ground; after which, the force of attraction is gradually reduced as wheels 29 run along output portion 31c, and is eliminated entirely as wheels 29 disengage guide 31. At this point, the ground coated sheet 2 can be removed off conveyor 9.

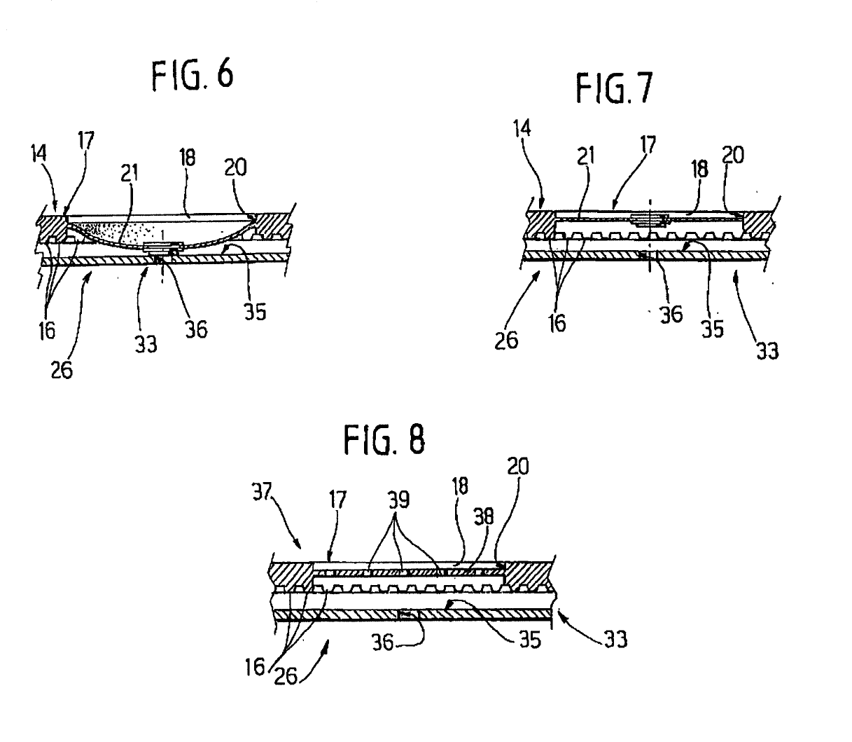

In the FIGS. 6 and 7 variation, as opposed to a mechanical control device, membrane 21 is activated by a pneumatic vacuum flexing device 33 comprising, in place of guide 31, a vacuum chamber 35 extending in place of guide 31 and closed at the top by belt 14, which is connected in known and fluidtight manner to guide track 15 and supporting structure 10. Chamber 35 communicates with a known vacuum unit (not shown) via one or more openings 36, each conveniently formed, in the example shown, at a respective membrane 21.

FIG. 8 shows a belt 37, which differs from belts 14 in the other Figures by comprising, in place of membrane 21, a substantially rigid wall 38 integral or not with the rest of belt 37 and having a number of openings 39 connecting chamber 35 to the outside.

In actual use, when membranes 21 are positioned over chamber 35, a vacuum is formed beneath each membrane 21 to flex the membrane 21 downwards and secure sheet 2 to surface 17. Without membrane 21, as in the FIG. 8 case, sheet 2 is retained by suction through perforated wall 38.

Conveyors 9 described therefore provide for feeding any type of sheet, and in particular coated sheets of glass, through one or more grinding units, without the retaining action for retaining the sheet on the conveyor affecting the surface of the sheet opposite the one resting on the conveyor, i.e. the coated surface. This is mainly due to the particular configuration of toothed belts 14, 37, which, like ordinary known toothed belts, define a continuous supporting surface for sheet 2 to safeguard sheet 2 against concentrated stress and cracking, but, unlike known solutions, provide for eliminating the top pressure belt which would affect the layer of coating material.

The straightforward design of belts 14, 37 and the possibility of controlling the vacuum exerted by the belt make conveyor 9 highly efficient and reliable and, at the same time, compact and extremely cheap to produce and maintain. Long-term efficiency and reliability are further improved by any damaged membranes 21 or perforated walls 38 being replaceable without having to replace the other membranes/perforated walls and/or the whole belt, the economic advantages of which are far from negligible considering the aggressive working environment of the belts, which, in the presence of cutting fluid, slivers and powdered glass, are subject to severe localized wear.

Clearly, changes may be made to conveyor 9 as described herein without, however, departing from the scope of the present invention. In particular, membranes 21 or walls 38 may be located differently with respect to supporting surface 17, e.g. be coplanar with the supporting surface, or may be formed otherwise than as described, e.g. be defined by a number of layers of similar or different materials. Membranes 21 may also be deformed by control devices other than those indicated. Conveyor 9 described may, obviously, also be employed on machines other than the one described by way of example, and in particular on vertical grinding machines on which the sheets of glass are fed substantially on edge.

1) A belt conveyor (9) for feeding a sheet (2) of glass on a machine (1) for grinding sheets of glass, the conveyor (9) comprising a supporting structure (10); and a powered toothed belt (14; 37) having a supporting surface (17) for supporting the sheet (2) of glass; characterized in that said toothed belt (14; 37) comprises retaining means (26) which act on the surface of the sheet (2) of glass facing said supporting surface (17) to keep the sheet (2) of glass in contact with said supporting surface (17).

2) A conveyor as claimed in claim 1, characterized in that said supporting surface (17) is a continuous surface.

3) A conveyor as claimed in claim 1, characterized in that said retaining means (26) are vacuum retaining means extending completely beneath said supporting surface (17).

4) A conveyor as claimed in claim 1, characterized in that said belt (14; 37) comprises a number of weakened intermediate portions (21; 38) distributed along the belt (14; 37); each said weakened intermediate portion forming part of said retaining means (26).

5) A conveyor as claimed in claim 4, characterized in that said belt (14; 37) comprises a number of cavities (20) open, in use, towards said sheet (2) of glass; each said weakened intermediate portion (21; 38) partly defining a respective said cavity (20).

6) A conveyor as claimed in claim 4, characterized in that each said weakened intermediate portion comprises an elastically deformable membrane (21).

7) A conveyor as claimed in claim 4, characterized in that said belt (14; 37) comprises a supporting portion (18) at least partly surrounding said weakened intermediate portions (21; 38); said supporting portion (18) and said weakened intermediate portions (21; 38) forming part of a one-piece body.

8) A conveyor as claimed in claim 4, characterized in that said belt (14; 37) comprises a supporting portion (18) defined by said supporting surface (17) at least partly surrounding said weakened intermediate portions (21; 38); each weakened intermediate portion (21; 38) forming part of a retaining member (22) separate from said supporting portion (18); and connecting means being provided to connect said retaining members (22) integrally to said supporting portion (18).

9) A conveyor as claimed in claim 8, characterized in that said connecting means are releasable connecting means.

10) A conveyor as claimed in claim 8, characterized in that said connecting means comprise an annular shoulder (24) for supporting a peripheral portion (23) of said retaining member (22).

11) A conveyor as claimed in claim 1, characterized in that said vacuum retaining means (26) comprise a vacuum chamber (35) connectable to vacuum means and at least partly closed by said belt (14; 37).

12) A conveyor as claimed in claim 4, characterized in that said belt (14; 37) comprises at least one through opening (39) communicating with said vacuum chamber (35).

13) A conveyor as claimed in claim 1, characterized in that said vacuum chamber is at least partly closed by said weakened intermediate portions (21; 38).

14) A conveyor as claimed in claim 4, characterized in that said retaining means comprise mechanical control means (30) for moving each said weakened intermediate portion (21) between a substantially undeformed rest condition and a deformed work condition in which said sheet (2) of glass is forced against said supporting surface (17).

15) A conveyor as claimed in claim 14, characterized in that said mechanical control means (30) comprise, for each said weakened intermediate portion (21), a respective control member (27) acting on the weakened intermediate portion (21); and actuating means (29, 31) for activating the control member (27).

16) A conveyor as claimed in claim 15, characterized in that said actuating means (29, 31) comprise cam and tappet means.

17) A conveyor as claimed in claim 16, characterized by comprising a slide surface (15) for said belt (14; 37); and in that said cam and tappet means comprise a guide (31), a straight portion of which extends parallel to and is spaced transversely apart from said slide surface (15).

18) A machine (1) for machining a sheet (2) of glass; the machine (1) comprising at least one grinding head (6); and conveying means (9) for feeding said sheet (2) of glass along a grinding path (P); characterized in that said conveying means comprise at least one toothed belt conveyor (9) as claimed in claim 1.
